(19) United States
(12) Patent Application Publication
(10) Pub. No.: US 2017/0249370 A1
(43) Pub. Date: Aug. 31, 2017

(54) METHOD AND APPARATUS FOR DATA PROCESSING

(71) Applicant: EMC IP Holding Company LLC, Hopkinton, MA (US)

(72) Inventors: Xiaoyan Guo, Beijing (CN); Chao Chen, Shanghai (CN); Yu Cao, Beijing (CN); Zed Minhong Zhou, Shanghai (CN); Dingmeng Xue, Shanghai (CN)

(21) Appl. No.: 15/440,620

(22) Filed: Feb. 23, 2017

(30) Foreign Application Priority Data
Feb. 25, 2016 (CN) 201610105872.3

(51) Int. Cl. G06F 17/30

(52) U.S. Cl. CPC G06F 17/30563

(57) ABSTRACT

A method and apparatus for data processing including receiving a data loading request from a data processor; in response to receiving the data loading request, obtaining requested raw data from a data memory; in response to the raw data being unstructured data, extracting, textual data from the raw data with a text extractor associated with a file type of the raw data; and transmitting the textual data to the data processor. Various embodiments can employ a uniform flow to process structured data and unstructured data. Through the uniform flow, textual information included in the unstructured data can be extracted in real time. Analysis of association between the text and the unstructured data can be performed conveniently in a same analysis task.

### RELATED APPLICATIONS

This application claim priority from Chinese Patent Application Number CN201610105872.3, filed on Feb. 25, 2016 at the State intellectual Property Office, China, titled “METHOD AND APPARATUS FOR DATA PROCESSING” the contents of which is herein incorporated by reference in its entirety

### FIELD

Embodiments of the present disclosure generally relate to the field of data processing, and more specifically, to a method and apparatus for data processing.

### BACKGROUND

Nowadays, enterprises generally build a data lake to hold a vast amount of their data. These data usually include structured data and unstructured data. For example, the structured data may include plain text files, JavaScript Object Notation (JSON) files, Comma Separated Value (CSV) files, database files and object files, etc. The unstructured data may usually include rich-text-format file, such as word documents, Portable Document Format (PDF) documents, presentation decks, and also multimedia data, i.e., audio and video files. Data processing and data analyzing workflows for the two kinds of data are generally different. Currently, prevalent big data processing frameworks, such as Hadoop, Spark, Hive, MPP (Multiple Physical Partition) databases, can directly and easily analyze the structured data such as plain textual data. However, for unstructured data, it is usually needed to first extract from these files textual data included, therein offline, store the extracted textual data and then process it.

Due to different processing flows with respect to structured data and unstructured data, processing and analyzing mass enterprise data will face several challenges. Firstly, it is hard to analyze association between structured data and unstructured data, because it can only be performed after performing complex extract-transform-load (EFL) operations to the unstructured data. Secondly, because it is needed to first extract from the unstructured data the textual data included therein offline and store the extracted textual data, a data inconsistency issue might arise and more storage space would be consumed.

Therefore, a more effective solution is needed in the art to solve the problems above.

### SUMMARY

Embodiments of the present disclosure intend to provide a method and apparatus for data processing so as to solve the problems above.

According to one aspect of the present disclosure, there is provided a method of data processing, comprising: receiving a data loading request from a data processor; in response to receiving the data loading request, obtaining requested raw data from a data memory; in response to the raw data being unstructured data, extracting textual data from the raw data with a text extractor associated with a file type of the raw data; and transmitting the textual data to the data processor.

In some embodiments, the method is performed with a data transformation layer disposed between the data processor and the data memory, and the data transformation layer hides details of transformation from the unstructured data to the textual data.

In some embodiments, the method further comprises: in response to the raw data being structured data, transmitting the raw data to the data processor.

In some embodiments, the structured data includes plain textual data.

In some embodiments, the unstructured data includes at least one of rich-text-format data and multimedia data.

In some embodiments, the receiving a data loading request from a data processor comprises: receiving the data loading request from the data processor via a data access interface, wherein the data access interface is uniform for both of structured data and unstructured data.

In some embodiments, the data memory includes a Hadoop distributed file system, and the obtaining requested raw data from a data memory comprises: obtaining, from a name node of the Hadoop distributed file system, information on a position where a file block of the raw data is located; and obtaining the file block from a data node corresponding to the position.

In some embodiments, the file type of the raw data includes a user-customized file type, and the extracting textual data from the raw data comprises: extracting the textual data from the raw data with a user-customized file extractor associated with the user-customized file type.

In some embodiments, the extracting textual data from the raw data comprises: extracting the textual data in real-time from the raw data with the text extractor.

According to another aspect of the present disclosure, there is provided an apparatus for data processing, comprising: a request receiving module configured to receive a data loading request from a data processor; a data obtaining module configured to obtain requested raw data from a data memory in response to receiving the data loading request; a text extracting module configured to extract, in response to the raw data being unstructured data, textual data from the raw data with a text extractor associated with a file type of the raw data; and a first transmitting module configured to transmit the textual data to the data processor.

In some embodiments, the apparatus is disposed between the data processor and the data memory, and the apparatus hides details of transformation from the unstructured data to the textual data.

In some embodiments, the apparatus further comprises a second transmitting module configured to transmit the raw data to the data processor in response to the raw data being structured data.

In some embodiments, the structured data includes plain textual data.

In some embodiments, the unstructured data includes at least one of rich-text-format data and multimedia data.

In some embodiments, the request receiving module is further configured to: receive the data loading request from the data processor via a data access interface, wherein the data access interface is uniform for both of structured data and unstructured data.

In some embodiments, the data memory includes a Hadoop distributed file system, and the data obtaining module is further configured to: obtain, from a name node of the Hadoop distributed file system, information on a position where a file block of the raw data is located; and obtain the file block from a data node corresponding to the position.

In some embodiments, the file type of the raw data includes a user-customized file type, and the text extracting module is further configured to: extract the textual data from the raw data with a user-customized file extractor associated with the user-customized file type.

In some embodiments, the text extracting module is further configured to: extract the textual data in real-time from the raw data with the textual extractor.

According to yet another aspect of the present disclosure, there is provided a computer program product of data processing, the computer program product being tangibly stored on a non-transient computer-readable medium and comprising machine-executable instructions that, when being executed, cause a machine to execute any step of the method.

Compared with the prior art, embodiments of the present disclosure can employ a uniform flow to process structured data and unstructured data. Through the uniform flow, textual information included in the unstructured data can be extracted in real time. Analysis of association between the text and the unstructured data can be performed conveniently in a same analysis task. Potential data inconsistency issue due to an offline processing can be avoided. Besides, through a plug-in mechanism, unstructured data of various file types can be supported, which can therefore enhance the scalability of data processing.

### BRIEF DESCRIPTION OF THE DRAWINGS

Through the following detailed description with reference to the accompanying drawings, the above and other objectives, features, and advantages of example embodiments of the present disclosure will become more apparent. Several example embodiments of the present disclosure will be illustrated by way of example but not limitation in the drawings in which:

FIG. 1 is a block diagram of an exemplary computer system/server 12 adapted to implement embodiments of the present disclosure;

FIG. 2 is an architecture diagram of a data processing system 200 according to embodiments of the present disclosure;

FIG. 3 is a schematic diagram of a workflow 300 for loading structured data according to embodiments of the present disclosure;

FIG. 4 is a schematic diagram of a workflow 400 for loading unstructured data according to embodiments of the present disclosure;

FIG. 5 is a flowchart of a method 500 for data processing according to embodiments of the present disclosure; and

FIG. 6 is a block diagram of an apparatus 600 for data processing according to embodiments of the present disclosure.

Throughout the drawings, the same or corresponding reference numerals represent the same or corresponding parts.

### DETAILED DESCRIPTION OF EMBODIMENTS

Principles of example embodiments disclosed herein will now be described with reference to various example embodiments illustrated in the drawings. It should be appreciated that description of those embodiments is merely to enable those skilled in the an to better understand and further implement example embodiments disclosed herein and is not intended for limiting the scope disclosed herein in any manner.

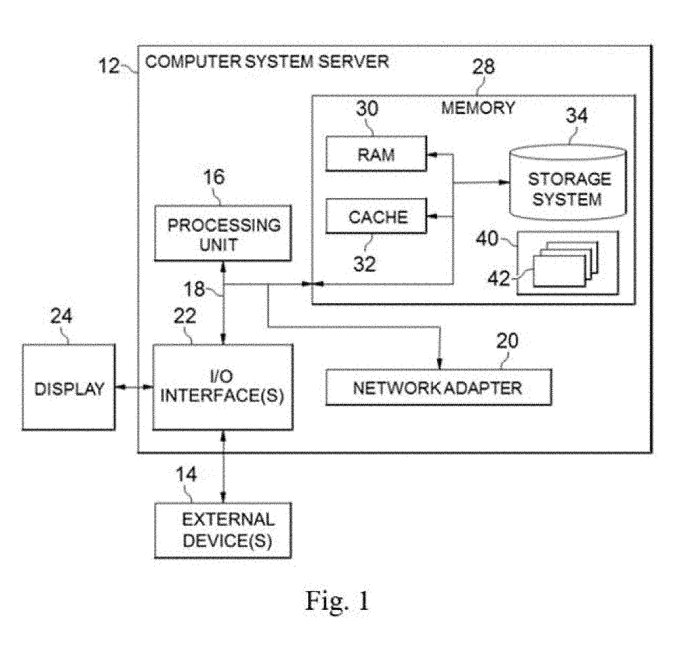

FIG. 1 is a block diagram of an exemplary computer system/server 12 adapted to implement embodiments of the present disclosure. The computer system/server 12 as shown in FIG. 1 is only an example, which should not bring any limitation to the functions and scope of use of the embodiments of the present disclosure.

As shown in FIG. 1, the computer system/server 12 is embodied in a manner of a general computing device. Components of the computer system/server 12 may include, but not limited to: one or more processors or processing units 16, a system memory 28, a bus 18 for connecting different system components (including the system memory 28 and the processing unit 16).

The bus 18 indicates one or more of several bus structures, including a memory bur or a memory controller, a peripheral bus, an accelerated graphics port, a processor, or a local area bus using any bus structure in a variety of bus structures. For example, these hierarchical structures include, but not limited to, an Industry Standard Architecture (ISA) bus, a Micro Channel Architecture (MCA) bus, an enhanced ISA bus, a Video Electronics Standards Association (VESA) local area bus, and a Peripheral Component Interconnect (PCI) bus.

The computer system/server 12 typically comprises a plurality of computer system readable mediums. These mediums may be any available medium that can be accessed by the computer system/server 12, including volatile and non-volatile mediums, mobile and immobile mediums.

The system memory 28 may comprise a computer system readable medium in a form of a volatile memory, e.g., a random access memory (RAM) 30 and/or a cache memory 32. The computer system/server 12 may further comprise other mobile/immobile, volatile/non-volatile computer system storage medium. Only as an example, the memory system 34 may be used for reading/writing immobile and non-volatile magnetic mediums (not shown in FIG. 1, generally referred to as “hard-disk driver”). Although not shown in FIG. 1, a disk driver for reading/writing a mobile non-volatile disk (e.g., “floppy disk”) and an optical disk driver for reading/writing a mobile non-volatile optical disk (e.g., CD-ROM, DVD-ROM or other optical medium) may be provided. In these cases, each driver may be connected to the bus 18 via one or more data medium interfaces. The memory 28 may include at least one program product that has a set of program modules (e.g., at least one). These program modules are configured to perform functions of various embodiments of the present disclosure.

A program/utility tool 40 having a set of program modules 42 (at least one) may be stored in for example the memory 28. This program module 42 includes, but not limited to, an operating system, one or more applications, other program modules, and program data. Each or certain combination in these examples likely includes implementation of a network environment. The program module 42 generally performs the functions and/or methods in the embodiments as described in the present disclosure.

The computer system/server 12 may also communicate with one or more external devices 14 (e.g., a keyboard, a pointing device, a display 24, etc.), and may also communicate with one or devices that cause the user to interact with the computer system/server 12, and/or communicate with any device (e.g., a network card, a modem, etc.) that causes the computer system/server 12 to communicate with one or more other computing devices. This communication may be carried out through an input/output (I/O) interface 22. Moreover, the computer system/server 12 may also communicate with one or more networks (e.g., a local area network (LAN), a wide area network (WAN) and/or a public network, e.g., Internet) via a network adaptor 20. As shown in the figure, the network adaptor 20 communicates with other modules of the computer system/server 12 via the bus 18. It should be understood that although not shown in the figure, other hardware and/or software modules may be used in conjunction with the computer system/server 12, including, but not limited to: microcode, device driver, redundancy processing unit, external disk drive array, RAID system, magnetic tape driver, and data backup storage system, etc.

In some embodiments of the present disclosure, in order to implement uniform processing on structured data and unstructured data, a uniform data transformation layer may be introduced between a data processing layer and a data storage layer of a data processing system, for reading and/or transforming data to be processed by the data processing layer.

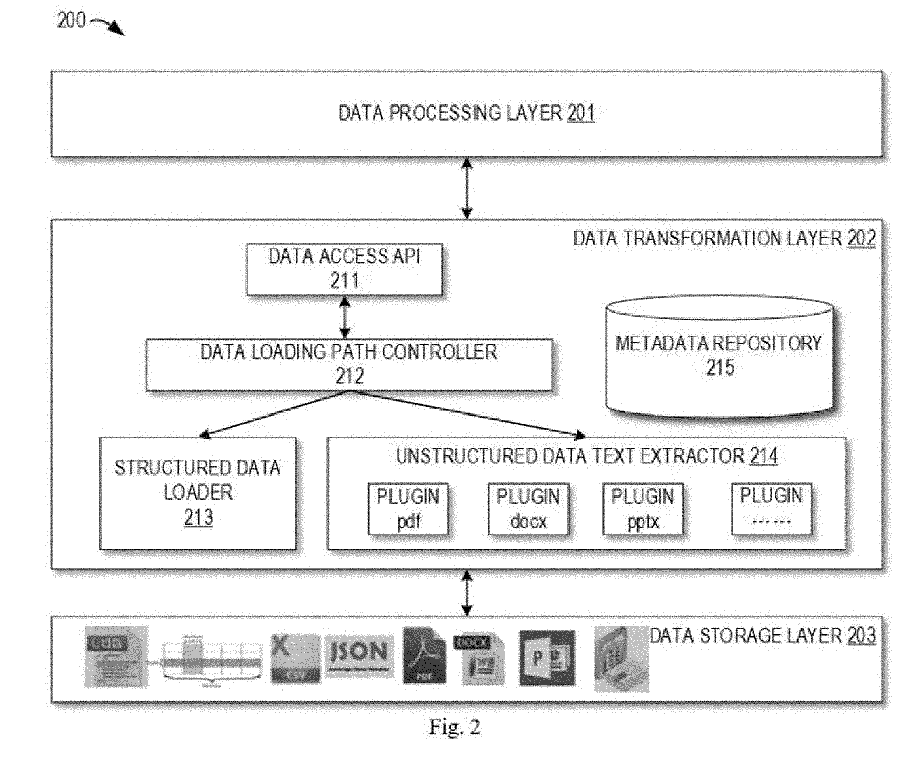

FIG. 2 is an architecture diagram of a data processing system 200 according to embodiments of the present disclosure. As illustrated in FIG. 2, in some embodiments of the present disclosure, the system 200 may comprise a data processing layer 201, a data transformation layer 202, and a data storage layer 203. For the sake of simplicity, the data transformation layer 202 in FIG. 2 will be focused in depiction. It should be understood that the data storage layer 203 may be implemented with any known and/or future developed technology, e.g., it may be implemented as a Hadoop distributed file system (HDFS), the scope of the present disclosure is not limited in this aspect. As illustrated in FIG. 2, different data access paths may be selected for different types of data in the data storage layer 203. When a data access request is received from the data processing layer 201, which is an upper layer of the data transformation layer 202, the data transformation layer 202 may traverse a corresponding data access path and extract metadata and textual data from raw data residing in the data storage layer 203 with a relevant content extraction plug-in. The extracted metadata and textual data may be directly returned to the data processing layer 201. As such, the data transformation layer 202 can hide details of transformation from unstructured data of different types to textual data.

As illustrated in FIG. 2, in some embodiments of the present disclosure, the data transformation layer 202 may comprise the following components: a data access application programming interface (API) 211, a data loading path controller 212, a structured data loader 213, an unstructured data text extractor 214, and a metadata repository 215.

The data access API 211 may be located on top of the data transformation layer 202, which is uniform for both of structured data and unstructured data. For example, the data access API may encapsulate all popular data access interfaces, e.g., an HDFS interface, a server message block (SMB) interface and/or a Java database connectivity (JDBC) interface, etc. The data processing layer 201 located above the data transformation layer 202 may transmit a data access request to the data access API 211. Upon receiving the data access request, the data access API 211 may route the data access request to other underlying interfaces. The data access API 211 may be compatible with other interfaces provided by various kinds of big data storage systems, such that the data transformation layer 202 can be transparent to the upper-layer data processing layer 201 and the implementation of the data processing 201 do not need to be changed or modified.

The data loading path controller 212 may determine which data loading path is used according to a file type of the requested data. For example, when the data processing layer 201 requests for structured data (e.g., plain textual data), the structured data loader 213 may be selected. When the data processing layer 201 requests for unstructured data (e.g., rich-text-format data), the unstructured data text extractor 214 may be selected.

The metadata repository 215 may be a data store that stores files of all formats in the data storage layer and any other useful metadata in the big data file system. The metadata repository 215 may be used by the data loading path controller 212 for selecting an appropriate data loading path.

The structured data loader 213 may encapsulate all original manners for loading and using structured data. Examples of the structured data loader 213 include without limiting to, a plain text reader, a CSV file reader, a JSON file interpreter and reader, a JDBC database connector and/or a target file reader, etc.

For unstructured data, such as rich-text-format data and multimedia data, the data processing system 200 usually needs their textual contents and metadata, rather than their specific formats, to perform data analysis work. The unstructured data text extractor 214 may be used to extract textual data in real time from the unstructured data. With the unstructured data text extractor 214, additional complex workflows might not be needed to offline extract textual data from these unstructured data. The unstructured data text extractor 214 may encapsulate a text extractor associated with a file type, such as PDF documents, Word documents, presentation documents, medical records, etc. In addition, the unstructured data text extractor 214 may be implemented with an extendable mechanism. For example, text extractors for different file types may be implemented as plug-ins. With the plug-in mechanism, the unstructured data text extractor 214 can have high scalability. For example, a new plug-in for a new type of unstructured data can be easily embedded into the data transformation layer 202. In addition, with the plug-in mechanism, the user may implement a self-customized text extractor for his/her own self-customized file type. For example, the user may only need to implement an interface for how to extract textual data from the self-customized file type. For example, the user do not need to implement other interfaces for obtaining raw data, transmitting the textual data to the data processing layer 201 and so on, because these interfaces are uniform for all file types.

Hereinafter, a specific workflow for data processing according to embodiments of the present disclosure will be described in conjunction with two specific examples. Only for the sake of illustration, HDFS is taken as an example of the data storage layer in the description below. The HDFS can support a big file storage by distributing data of the file among data nodes and storing metadata of the file on name nodes.

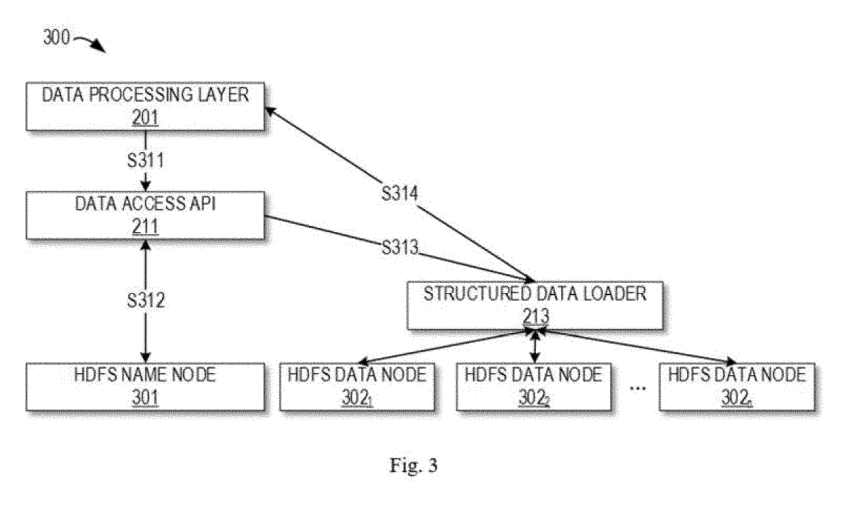

FIG. 3 is a schematic diagram of a workflow 300 for loading structured data in some embodiments of the present disclosure. At the ease of depiction, FIG. 3 illustrates the data processing layer 201, the data access API 211, and the structured data loader 213 as shown in FIG. 2. Besides, FIG. 3 also shows a name node 301 and one or more data nodes 302₁, 302₂, 302ₙ (hereinafter collectively referred to as data node 302), which are all included in the HDFS. As illustrated in FIG. 3, the workflow 300 may comprise steps S311 to S314.

The data processing layer 201 may transmit (S311) a data loading request for structured data to the data access API 211 that belongs to the data transformation layer 202. The data access API 211 may parse the data loading request (e.g., so as to determine that the requested data is structured data), and obtain (S312) metadata and a location of a file block of the data from the name node 301. Upon obtaining the locations of all of file blocks, the data access API 211 may transmit a command to the corresponding structured data loader 213 so as to obtain (S313) the raw data from the corresponding data node 302. The structured data loader 213 may directly transmit (S314) the raw data (i.e., the requested structured data) to the data processing layer 201.

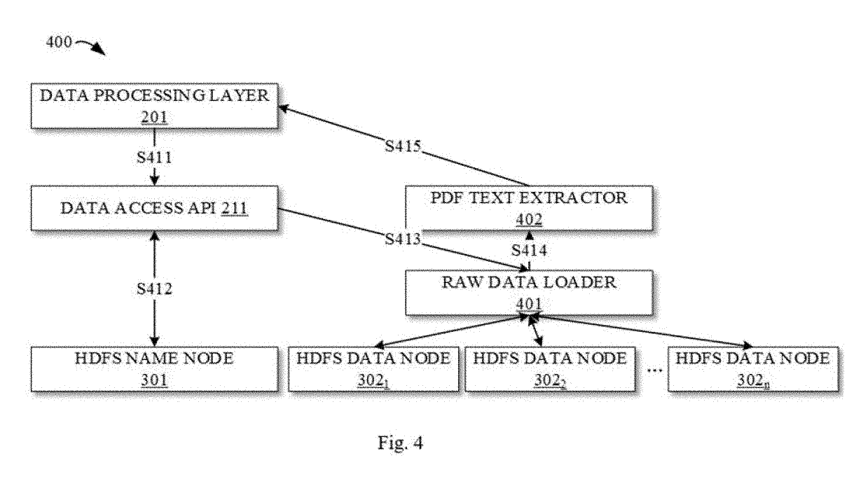

FIG. 4 is a schematic diagram of a workflow 400 for loading unstructured data in some embodiments of the present disclosure. At the ease of depiction, FIG. 4 illustrates the data processing layer 201 and the data access API 211 as shown in FIG. 2, as well as the name node 301 and the data node 302 included in the HDFS. In addition, FIG. 4 also illustrates an raw data loader 401 and a PDF text extractor 402. For example, both of them may be implemented as parts of the unstructured data text extractor 214 as shown in FIG. 2, where the raw data loader 401 is uniform for unstructured data of different file types, and the PDF text extractor 402 is a text extractor plug-in associated with PDF documents. As illustrated in FIG. 4, the workflow 400 may comprise steps S411-S415.

The data processing layer 201 may transmit (S411) a request for reading textual content within a PDF file in an HDFS to the data application API 211. The data access API 211 may obtain (S412) locations of all file blocks of the PDF file from the name node 301. Upon obtaining the locations of all file blocks, the data access API 211 may transmit a command to the raw data loader 401 so as to obtain (S413) raw data from the corresponding data node 302. The raw data loader 401 may transmit (S414) the obtained raw data (i.e., the raw PDF document) to the PDF text extractor 402. The PDF text extractor 402 may extract textual data from the received raw data (i.e., the raw PDF document) and then transmit (S415) the extracted textual data to the data processing layer 201.

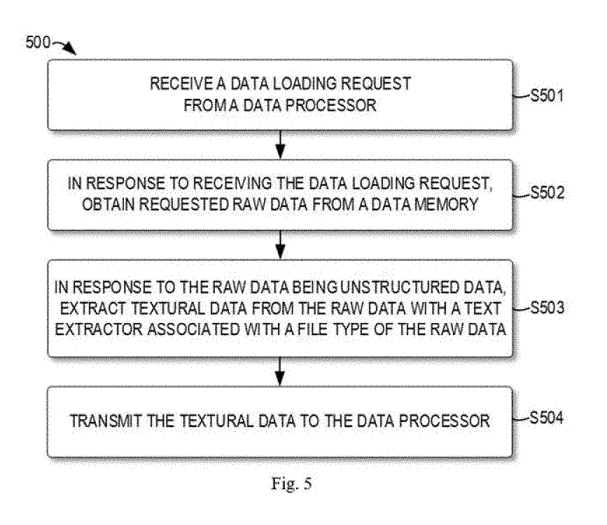

FIG. 5 is a flowchart of a method 500 for data processing according to embodiments of the present disclosure. For example, the method 500 may be implemented by the data transformation layer 202 as illustrated in FIG. 2. As illustrated in FIG. 5, the method 500 may comprise steps S501-S502.

At S501, a data loading request is received from a data processor. For example, the data processor here may be implemented as a data processing layer 201 illustrated in FIG. 2, The data loading request may comprise a structured data loading request or an unstructured loading request. According to the embodiments of the present disclosure, step S501 may comprise receiving a data load request from the data processor via a data access interface (e.g., a data access API 211 shown in FIG. 2), wherein the data access interface is uniform for both of the structured data and unstructured data.

The method 500 proceeds to S502, in response to receiving the data loading request, the requested raw data is obtained from a data memory For example, the data memory here may be implemented as the data storage layer 203 as shown in FIG. 2. In some embodiments of the present disclosure, if the data loading request is for structured data, the requested raw data may be obtained from the data memory with the structured data loader 213 as shown in FIG. 2. If the data loading request is for unstructured data, the requested raw data may be obtained from the data memory with the unstructured data text extractor 214 as shown in FIG. 2 (e.g., including the raw data loader 402 as shown in FIG. 4). In some embodiments of the present disclosure, the data memory may include a HDFS, and then the step S502 may comprise obtaining information on a position where a file block of the raw data is located from a name node of the HDFS; and obtaining the file block from a data node corresponding to the position.

The method 500 proceeds to step S503 where in response to the raw data being unstructured data, textual data is extracted from the raw data with a text extractor associated with a file type of the raw data. For example, according to S415 as shown in FIG. 4, the included textual data may be extracted from a PDF document with the PDF text extractor 402. In some embodiments of the present disclosure, the file type of the raw data may include a user-customized file type, and thus the step S503 may comprise extracting textual data from the raw data with a user-customized text extractor associated with the user-customized file type. In some embodiments of the present disclosure, the extraction of the textual data is performed online in real-time, which thus can avoid the data inconsistency issue possibly caused by an offline processing.

The method 500 proceeds to step S504 to transmit textual data to the data processor. For example, at step S415 as shown in FIG. 4, the PDF text extractor 402 may transmit the extracted textual data to the data processing layer 201.

In some embodiments of the present disclosure, the method 500 may further comprise: in response to the raw data being unstructured data, transmitting the raw data to the data processor. For example, at step S314 as shown in FIG. 3, the structured data loader 213 may directly transmit the obtained raw data (i.e., the structured data) to the data processing layer 201.

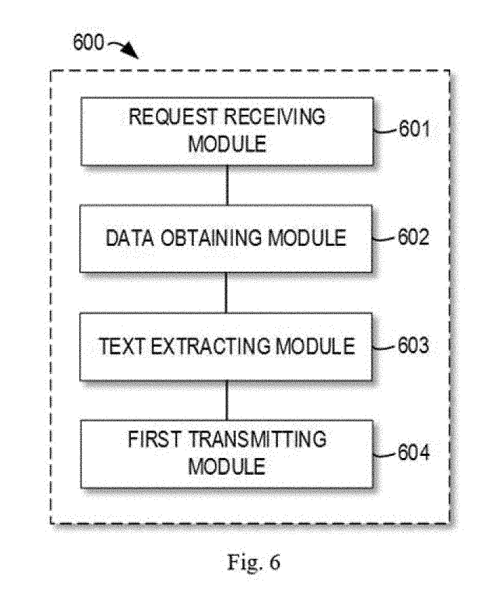

FIG. 6 is a block diagram of an apparatus 600 for data processing according to embodiments of the present disclosure. For example, the apparatus 600 may be implemented as the data transformation layer as shown in FIG. 2. As illustrated in FIG. 6, the apparatus 600 may comprise: a request receiving module 601 configured to receive a data loading request from a data processor; a data obtaining module 602 configured to obtain requested raw data from a data memory in response to receiving the data loading request; a text extracting module 603 configured to extract, in response to the raw data being unstructured data, textual data from the raw data with a text extractor associated with a file type of the raw data; and a first transmitting module 604 configured to transmit the textual data to the data processor.

In some embodiments of the present disclosure, the apparatus 600 may be disposed between the data processor and the data memory, and the apparatus hides details of transformation from the unstructured data to the textual data.

In some embodiments of the present disclosure, the apparatus 600 further comprises a second transmitting module configured to transmit the raw data to the data processor in response to the raw data being structured data.

In some embodiments of the present disclosure, the structured data may include plain textual data, and the unstructured data may include at least one of rich-text-format data and multimedia data.

In some embodiments of the present disclosure, the request receiving module 601 may be further configured to: receive the data loading request from the data processor via a data access interface, wherein the data access interface is uniform for both of structured data and unstructured data.

In some embodiments of the present disclosure, the data memory may include a HDFS, and the data acquiring module 602 may be further configured to: obtain, from a name node of the Hadoop distributed file system, information on a position where a file block of the raw data is located; and obtain the file block from a data node corresponding to the position.

In some embodiments of the present disclosure, the file type of the raw data includes a user-customized file type, and the text extracting module 603 may be further configured to: extract the textual data from the raw data with a user-customized file extractor associated with the user-customized file type. Additionally or alternatively, the text extracting module 603 may be further configured to: extract the textual data in real-time from the raw data with the textual extractor.

For the sake of clarity, FIG. 6 does not show some optional modules of the apparatus 600. However, it should be understood that respective features described above with reference to FIGS. 2-5 are also suitable for the apparatus 600. Moreover, respective modules in the apparatus 600 may be hardware modules or software modules. For example, in some embodiments, the apparatus 600 may be implemented partially or fully with software and/or firmware, e.g., implemented as a computer program product embodied on a computer readable medium. Alternatively or additionally, the apparatus 600 may be implemented partially or fully based on hardware, e.g., implemented as an integrated circuit (IC), an application-specific integrated circuit (ASIC), a system on chip (SOC), a field programmable gate array (FPGA), etc. The scope of the present disclosure is not limited in this aspect.

In view of the above, the embodiments of the present disclosure can provide a method and apparatus for data processing. Compared with the prior art, embodiments of the present disclosure can employ a uniform flow to process structured data and unstructured data. Through the uniform flow, textual information included in the unstructured data can be extracted in real time. Analysis of association between the text and the unstructured data can be performed conveniently in a same analysis task. Potential data inconsistency issue due to an offline processing can be avoided. Besides, through a plug-in mechanism, unstructured data of various file types can be supported, which can therefore enhance the scalability of data processing.

The embodiments of the present disclosure may be a method, an apparatus and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk. C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions; acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present invention. In this regard, each block in the flowchart or block diagrams may represent a module, snippet, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I/we claim:

1. A method of data processing, comprising:
receiving a data loading request from a data processor;
in response to receiving the data loading request, obtaining requested raw data from a data memory;
in response to the raw data being unstructured data, extracting textual data from the raw data with a text extractor associated with a file type of the raw data; and
transmitting the textual data to the data processor.

2. The method of claim 1, wherein the method is performed with a data transformation layer disposed between the data processor and the data memory, and the data transformation layer hides details of transformation from the unstructured data to the textual data.

3. The method of claim 1, further comprising:
in response to the raw data being structured data, transmitting the raw data to the data processor.

4. The method of claim 3, wherein the structured data includes plain textual data.

5. The method of claim 1, wherein the unstructured data includes at least one of rich-text-format data and multimedia data.

6. The method of claim 1, wherein the receiving a data loading, request from a data processor comprises:
receiving the data loading request from the data processor via a data access interface, the data access interface being uniform for both of structured data and unstructured data.

7. The method of claim 1, wherein the data memory includes a Hadoop distributed file system and the obtaining requested raw data from a data memory comprises:
obtaining, from a name node of the Hadoop distributed file system, information on a position where a file block of the raw data is located; and
obtaining the file block from a data node corresponding to the position.

8. The method of claim 1, wherein a file type of the raw data includes a user-customized file type, and the extracting textual data from the raw data comprises:
extracting the textual data from the raw data with a user-customized file extractor associated with the user-customized file type.

9. The method of claim 1, wherein the extracting textual data from the raw data comprises:
extracting the textual data in real-time from the raw data with the text extractor

10. An apparatus for data processing, comprising:
a request receiving module configured to receive a data loading request from a data processor;
a data obtaining module configured to obtain requested raw data from a data memory in response to receiving the data loading request;
a text extracting module configured to extract, in response to the raw data being unstructured data, textual data from the raw data with a text extractor associated with a file type of the raw data; and
a first transmitting module configured to transmit the textual data to the data processor

11. The apparatus of claim 10, wherein the apparatus is disposed between the data processor and the data memory, and the apparatus hides details of transformation from the unstructured data to the textual data.

12. The apparatus of claim 10, further comprising:
a second transmitting module configured to transmit the raw data to the data processor in response to the raw data being structured data.

13. The apparatus of claim 12, wherein the structured data includes plain textual data.

14. The apparatus of claim 10, wherein the unstructured data includes at least one of rich-text-format data and multimedia data.

15. The apparatus of claim 10, wherein the request receiving module is configured to:
receive the data loading request from the data processor via a data access interface, the data access interface being uniform for both of structured data and unstructured data.

16. The apparatus of claim 10, wherein the data memory includes a Hadoop distributed file system, and the data obtaining module is configured to:
obtain, from a name node of the Hadoop distributed file system, information on a position where a file block of the raw data is located; and
obtain the file block from a data node corresponding to the position.

17. The apparatus of claim 10, wherein a file type of the raw data includes a user-customized file type, and the text extracting module is configured to:
extract the textual data from the raw data with a user-customized file extractor associated with the user-customized file type.

18. The apparatus of claim 10, wherein the text extracting module is configured to:
extract the textual data in real-time from the raw data with the textual extractor.

19. A computer program product for data processing, the computer program product comprising:
a non-transitory computer readable medium encoded with computer-executable code, the code configured to enable the execution of:
receiving a data loading request from a data processor;
in response to receiving the data loading request, obtaining requested raw data from a data memory;
in response to the raw data being unstructured data, extracting textual data from the raw data with a text extractor associated with a file type of the raw data; and
transmitting the textual data to the data processor.

20. The computer program product of claim 19, wherein a data transformation layer is disposed between the data processor and the data memory, and the data transformation layer hides details of transformation from the unstructured data to the textual data.
